(19) United States
(12) Patent Application Publication
(10) Pub. No.: US 2010/0296266 A1
(43) Pub. Date: Nov. 25, 2010

(54) Lighting Device

(75) Inventors: David Dussault, Neutraubling (DE); Ralph Peter Bertram, Nitendorf (DE); Matthias Fiegler, Deisenhofen (DE); Horst Varga, Lappersdorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Gesellschaft mit beschränkter Haftung, Münich (DE)

(21) Appl. No.: 12/678,266

(22) PCT Filed: Sep. 12, 2008
(86) PCT No.: PCT/DE08/01535

§ 371 Date: Aug. 9, 2010

(30) Foreign Application Priority Data
Sep. 14, 2007 (DE) 10 2007 043 903.4

(51) Int. Cl. F21V 9/16; F21V 7/00; F21V 7/06; F21V 7/07; F21V 7/08

(52) U.S. Cl. 362/84; 362/235

(57) ABSTRACT

A luminous device (10) comprising at least one reflector (6) and comprising at least one luminous module (1) which has at least one radiation-emitting semiconductor component (3) and a component carrier (2) having at least one mounting area (4a, 4b) on which the radiation-emitting semiconductor component (3) is mounted. The luminous module (1) is connected to the reflector (6) in a connection plane (V) defined by points of contact between the component carrier (2) and the reflector (6. The mounting area (4a, 4b) extends obliquely with respect to the connection plane (V).

Different variants of a luminous device are described in the present case, wherein the luminous device has at least one luminous module.

This patent application claims the priority of German patent application No. 102007043903.4, the disclosure content of which is hereby incorporated by reference.

The patent specification DE 199 09 399 C1 discloses a flexible LED multiple module suitable for incorporation into luminaire housings, in particular for motor vehicles. The LED multiple module has a plurality of LEDs mounted onto rigid circuit boards.

In the present case, one object to be achieved consists in specifying a luminous device having improved optical properties. This object is achieved by means of a luminous device in accordance with patent claim 1.

Advantageous developments of the luminous device are specified in the dependent patent claims.

In accordance with one preferred variant of the invention the luminous device comprises at least one reflector and at least one luminous module which has at least one radiation-emitting semiconductor component and a component carrier having at least one mounting area on which the radiation-emitting semiconductor component is mounted, wherein the luminous module is connected to the reflector in a connection plane defined by points of contact between the component carrier and the reflector, wherein the mounting area extends obliquely with respect to the connection plane.

Preferably, a planar area extending parallel to the connection plane and thus obliquely with respect to the mounting area of the component carrier is illuminated by means of the radiation generated by the luminous module.

Radiation generated by means of an oblique arrangement of this type preferably forms an angle of greater than 0° and less than 90° with the area normal to the planar area to be illuminated. In comparison with a conventional flat arrangement with perpendicular incidence of radiation, in the present case the path length of the radiation as far as the planar area to be illuminated is larger. This advantageously results overall in better intermixing of the radiation from adjacent semiconductor components and thus an improved radiation homogeneity.

In one advantageous configuration of the luminous device, the luminous module is arranged within the reflector. In this way, in particular, the radiation generated by the individual semiconductor components of the luminous module can be reflected by means of the reflector. Preferably, the radiation is reflected a number of times in the reflector, with the result that the distance covered by the radiation in the reflector is increased. This, too, results in better intermixing of the radiation, that is to say that the radiation homogeneity of the radiation emitted by the luminous device is improved.

In comparison with a luminous device without a reflector, the present luminous device can be produced with a relatively small structural depth since a sufficient radiation homogeneity can be obtained by means of the reflector even with a smaller structural depth.

Furthermore, the radiation generated by the individual semiconductor components of the luminous module can be concentrated by means of the reflector. By way of example, a radiation cone generated by the luminous device can be restricted to a predetermined aperture angle by means of the reflector.

Furthermore, the reflector can reflect the radiation emitted by the luminous module in a main emission direction. Preferably, the main emission direction extends parallel to the area normal to the planar area to be illuminated.

In accordance with one preferred variant, a cross-sectional area of the reflector which extends parallel to the connection plane becomes larger in the main emission direction. This means that the reflector has a form that opens upward, that is to say in the main emission direction.

In accordance with a further preferred variant, the reflector has a symmetrical cross-sectional form in at least one plane arranged perpendicular to the connection plane. By way of example, the cross-sectional form can be a parabola segment or a parabola, an ellipse segment, or a hyperbola segment. The surface of the reflector can therefore be curved at least in places. However, the surface can also be at least partly or completely planar. In particular, the cross-sectional form can be a trapezoid segment.

In the case of a symmetrical embodiment of the reflector, the luminous module is preferably arranged on an axis of symmetry of the reflector. Particularly preferably, the axis of symmetry is parallel to the main emission direction.

In one advantageous configuration of the luminous device, the reflector is embodied in specularly reflective fashion, that is to say that the reflector reflects the radiation in such a way that the angle of reflection is equal to the angle of incidence. In this case, the reflector can have a smooth metal surface. However, it is also possible for the reflector to be diffusely reflective. In this case, the reflector can have a surface having scattering centers, for example a roughened surface wherein the scattering centers can reflect the radiation in all spatial directions.

In accordance with one preferred embodiment, the reflector is formed from a plastic film. Such an embodiment of the reflector permits a relatively light design of the reflector. In particular, plastic film is a thermal film that can be brought to the desired form upon heating.

Preferably, the reflector encloses a cavity in which the luminous module is arranged, that is to say that the reflector is not embodied as a solid body. The reflector has an advantageously low weight as a result.

Furthermore, the surface of the reflector does not have to be a closed area, but rather can have an opening at the base, for example, in which the luminous module is arranged. In particular, the luminous module is arranged in such a way that the base opening of the reflector is closed by the luminous module.

In accordance with a further variant, the reflector is coated with a phosphor. The phosphor can convert at least one part of the radiation originating from the semiconductor components into radiation having a higher wavelength. By mixing the original radiation with the converted radiation, it is possible to generate mixed-colored light, in particular white light. It is possible to use phosphors of different types, such that diverse color mixtures and color temperatures can be obtained. Suitable phosphors, such as a YAG:Ce powder, for instance, are described for example in WO 98/12757, the content of which in this respect is hereby incorporated by reference.

The entirety of the semiconductor components of the luminous module can generate identically colored light. However, it is also conceivable for at least two semiconductor components to generate radiation of different colors. Mixed-colored light, in particular white light can thereby be generated. By way of example, the luminous module can have a first component emitting red light, a second component emitting green light, and a third component emitting blue light. By means of a combination of different-colored components, it is possible to obtain a comparatively good color rendering index. Furthermore, the white point can be shifted by means of different mixing of red, green and blue light.

Semiconductor components which are surface-mountable are suitable for the luminous module. Semiconductor components of this type permit simple mounting thereof and thus contribute to reducing the production complexity for the luminous module. Each semiconductor component typically has a housing body, in which at least one radiation-emitting semiconductor body is arranged. A semiconductor component which is suitable in the context of the invention is known from the document WO 02/084749 A2, the content of which is hereby incorporated by reference.

In one advantageous configuration of the luminous device, the luminous module comprises a component carrier having at least one first and one second mounting area which extend obliquely with respect to one another. As an alternative, the two mounting areas can also extend parallel to one another. In this case, the component carrier is embodied in parallelepipedal fashion, in particular.

Furthermore, the first mounting area and the second mounting area can form the same angle with the connection plane. However, it is also conceivable for the mounting areas to form different angles with the connection plane. Advantageously, it is possible to homogeneously illuminate an area in an edge region, too, if the luminous device has, in the edge region, a luminous module in which the mounting areas form different angles with the module carrier. A luminous module arranged in the inner region, by contrast, preferably has in this case mounting areas which form the same angle with the module carrier.

The component carrier firstly serves for fixing the components. Secondly, the component carrier can have, for interconnecting the components, conductor track structures and electrical connections which are connected to a power supply. In particular the component carrier has at least one circuit board, wherein the mounting area is the surface of the circuit board. The component carrier can consist solely of a circuit board, which is bent in such a way that at least two surfaces of the circuit board extend obliquely with respect to one another. As an alternative, the component carrier can have a holder having at least two surfaces extending obliquely with respect to one another, wherein a circuit board is fixed on at least one surface. The holder preferably contains a metal and particularly preferably consists of aluminum or copper. A suitable circuit board is a metal-core circuit board, for example, which provides for comparatively good cooling of the luminous module. Furthermore, the circuit board can have plated-through holes for the purpose of conducting heat. The circuit board can be a flexible circuit board which can be easily adapted to the form of the holder.

In accordance with one preferred configuration of the luminous device, the component carrier has the form of a polyhedron. In this case it is not necessary for the form of the component carrier to produce a closed polyhedron form. Rather, the form of a polyhedron can be indicated by the component carrier. Preferred polyhedra are prism, tetrahedron, pyramid or parallelepiped, for example.

In accordance with a further preferred configuration of the luminous device, the at least one mounting area of the component carrier is arranged parallel to a boundary face of the polyhedron.

In one advantageous variant of the luminous device, the component carrier is a frame provided for guiding a cooling fluid flow or for arranging a cooling element. In the present case, fluid should be understood to mean a liquid or a gas. By way of example, the fluid flow can be an air flow that is brought about by convection or by means of a fan. The heat that arises during the operation of the luminous module can thereby be advantageously dissipated to the surroundings. A plurality of cooling fins, for example, are suitable as cooling element.

In accordance with one preferred embodiment, the luminous device has a plurality of reflectors, wherein at least one luminous module is arranged respectively in a reflector. Upon illumination of a planar area, a partial region of the area can be illuminated by means of a unit composed of reflector and luminous module, said partial region being referred to hereinafter as luminous segment. Preferably, the at least one luminous module (arranged in one reflector) is in each case electrically driveable independently of the luminous modules arranged in the other reflectors. It is thereby possible to produce on the planar area individual luminous segments which produce, by way of example, a line-by-line or rectangular illumination of the area to be illuminated. Suitable aspect ratios of a rectangular luminous segment are 16:9 or 4:3, for example. A contour of the reflector can accordingly have said aspect ratios. The aspect ratios are advantageously adapted to conventional screen formats. As a result the luminous device can optimally be used for backlighting a screen, for example an LCD (liquid crystal display). The screen, in general terms a backlighting element, is disposed downstream of the reflector.

Furthermore, a covering plate can be disposed downstream of the reflector. Said covering plate is typically situated before the backlighting element in the main emission direction. The covering plate can be provided, in particular, for protecting the luminous module from damage. Furthermore, the covering plate can be a diffuser, whereby the radiation is intermixed better. The covering plate can bear on the reflector and thereby be stabilized by means of the reflector. This has the consequence that the bearing points can be discerned as boundaries between the luminous segments of the area to be illuminated. By contrast, in the alternative embodiment, wherein the covering plate is spaced apart from the reflector, no boundaries can be seen.

In the present case, it is advantageous if the mounting area extends obliquely with respect to a main area of the backlighting element. In this case, the mounting area of the component carrier forms an angle of greater than 0° and less than or equal to 90° with the main area of the backlighting element. In this case, the main area is the planar area to be illuminated.

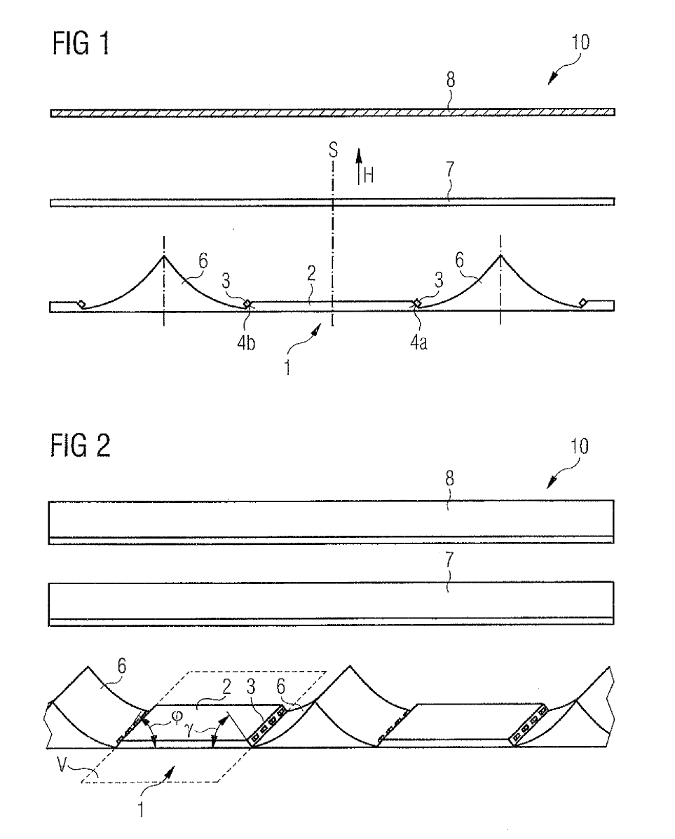

Further preferred features, advantageous configurations and developments and also advantages of a luminous device according to the invention will become apparent from the exemplary embodiments explained in greater detail below in association with FIGS. 1 to 15.

In the figures:

FIG. 1 shows a schematic cross-sectional view of a first exemplary embodiment of a luminous device according to the invention,

FIG. 2 shows a perspective view of the exemplary embodiment illustrated in FIG. 1,

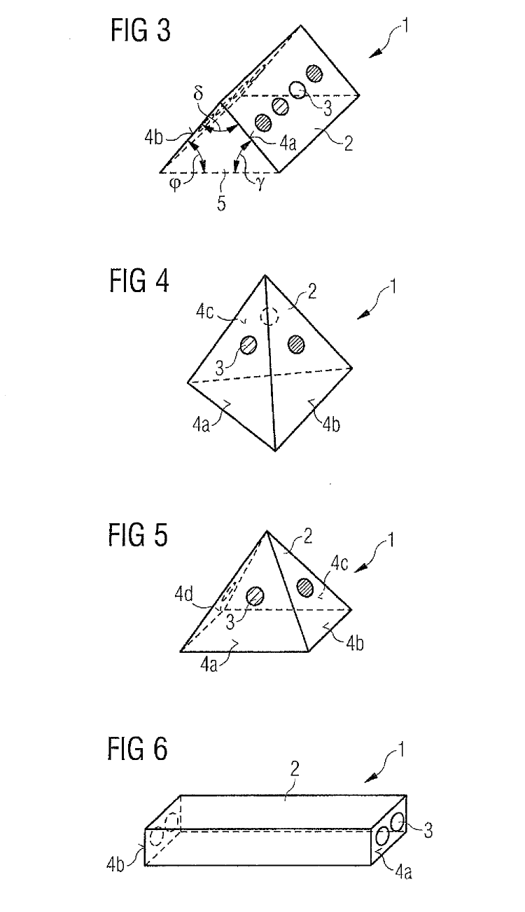

FIG. 3 shows a schematic perspective view of a first exemplary embodiment of a preferred luminous module,

FIG. 4 shows a schematic perspective view of a second exemplary embodiment of a preferred luminous module,

FIG. 5 shows a schematic perspective view of a third exemplary embodiment of a preferred luminous module,

FIG. 6 shows a schematic perspective view of a fourth exemplary embodiment of a preferred luminous module,

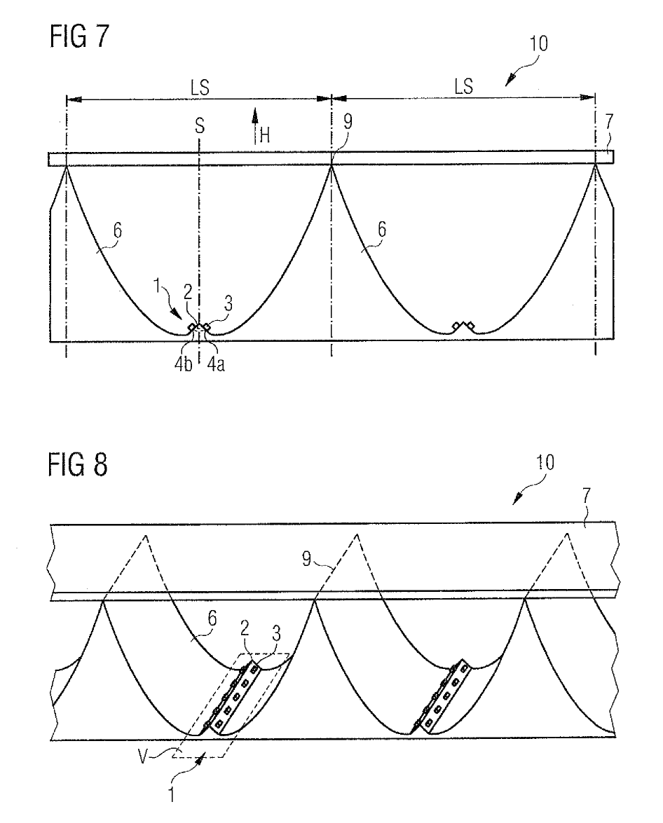

FIG. 7 shows a schematic cross-sectional view of a second exemplary embodiment of a luminous device according to the invention,

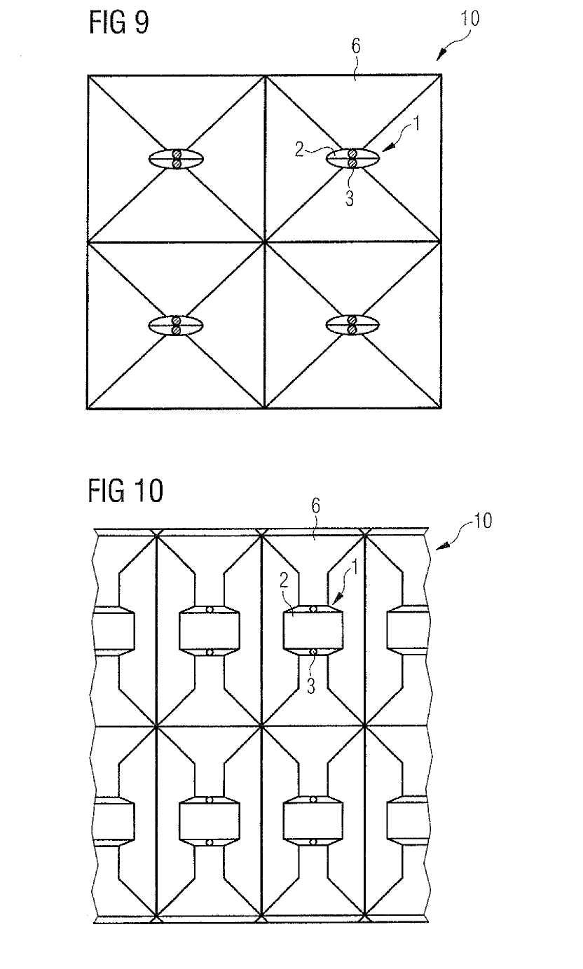

FIG. 8 shows a perspective view of the exemplary embodiment illustrated in FIG. 7,

FIG. 9 shows a schematic plan view of a third exemplary embodiment of a luminous device according to the invention,

FIG. 10 shows a further schematic plan view of the exemplary embodiment illustrated in FIG. 9,

FIG. 11 shows a schematic perspective view of a unit of a fourth exemplary embodiment of a luminous device according to the invention,

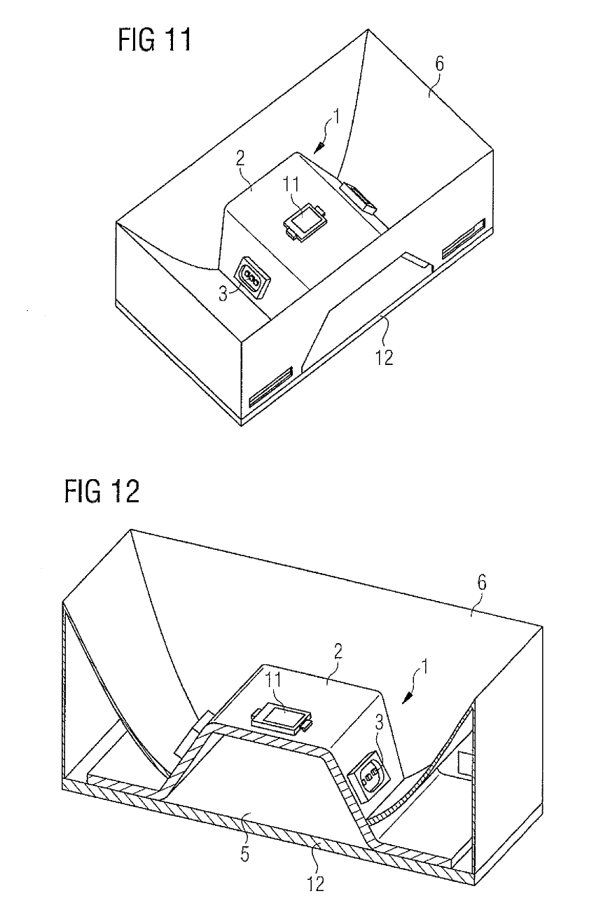

FIG. 12 shows a further schematic perspective cross-sectional view of the exemplary embodiment illustrated in FIG. 11,

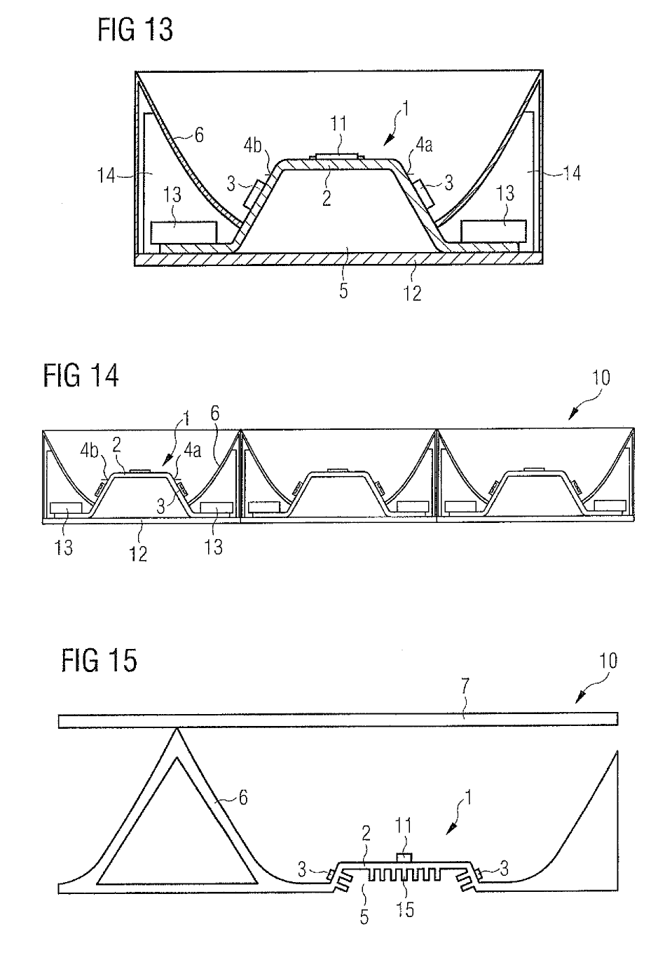

FIG. 13 shows a schematic cross-sectional view of a unit of a fifth exemplary embodiment of a luminous device according to the invention,

FIG. 14 shows a schematic cross-sectional view of a sixth exemplary embodiment of a luminous device according to the invention,

FIG. 15 shows a schematic cross-sectional view of a seventh exemplary embodiment of a luminous device according to the invention.

FIGS. 1 and 2 illustrate a luminous device 10 comprising a plurality of luminous modules 1 and reflectors 6. A luminous module 1 having a plurality of semiconductor components 3 is arranged in each reflector 6, wherein the semiconductor components 3 are mounted on a component carrier 2. In particular, the semiconductor components 3 are arranged on side areas of the component carrier 2, which is embodied like a truncated pyramid, which side areas thus serve as mounting areas 4a and 4b.

The mounting areas 4a and 4b extend obliquely with respect to a connection plane V defined by points of contact between the component carrier 2 and the reflector 6. The connection plane V is preferably arranged parallel to a bearing area of the luminous device 10. The mounting area forms the angle γ with the connection plane V, where 0°<γ≦90° holds true. The angle φ formed by the mounting area. 4b with the connection plane V can be 0°<φ≦90°. The angle γ and the angle φ can be different or equal in magnitude.

Radiation generated by the semiconductor components 3 impinges for the most part on the reflector 6 and is preferably reflected in the main emission direction H. In comparison with a conventional arrangement having an emission direction parallel to the main emission direction H, in the present case the path length of the radiation as far as a planar area to be illuminated is larger. This advantageously results overall in better intermixing of the radiation and thus an improved radiation homogeneity on the planar area. The planar area is preferably a main area of a backlighting element 8.

As can be discerned in FIG. 5, the reflector 6 is embodied symmetrically with respect to an axis of symmetry S extending perpendicular to the connection plane V. The luminous module 1 is advantageously arranged on the axis of symmetry S. The cross-sectional form of the reflector 6 constitutes a parabola segment in this exemplary embodiment.

The reflector 6 is arranged at the longitudinal sides of the luminous module 1. The luminous device 10 has no reflector at the broad sides of the component carrier 3. Further luminous devices can be arranged here instead, such that the reflectors arranged one behind another produce a grooved form which enables line-by-line illumination of a planar area.

In the case of a relatively flat reflector 6, as illustrated in FIGS. 1 and 2, the reflector 6 does not reach as far as the covering plate 7, which is a diffuser, for example. The radiation from adjacent luminous modules 1 can thus mix, as a result of which upper edges 9 of the reflector 6 cannot be discerned by an observer.

FIGS. 3 to 6 illustrate luminous modules which are particularly suitable for the luminous device described in the present case.

The luminous module 1 illustrated in FIG. 3 has a component carrier 2 and a plurality of semiconductor components 3, wherein the semiconductor components 3 are arranged on a first mounting area 4a and a second mounting area 4b of the component carrier 2. As denoted in FIG. 3, the first mounting area 4a and the second mounting area 4b extend obliquely with respect to one another, that is to say that they form an angle δ, where 0°<δ<180° holds true.

Thus, the component carrier 2 is embodied in angular fashion in the exemplary embodiment illustrated, such that a cavity 5 is present below the component carrier 2, in which cavity a cooling element, for example, can be arranged. The component carrier 2 can be embodied as one part or in multipartite fashion. Preferably, for producing a multipartite component carrier 2, circuit boards are joined together, such that the circuit boards form the angle δ. Preferably, the circuit boards are then arranged on a holder (not illustrated). The respective surfaces of the circuit boards then form the mounting areas 4a and 4b of the component carrier 2. The circuit boards are metal-core circuit boards, in particular, which provide for good cooling of the luminous module 1.

Furthermore, the two mounting areas 4a and 4b extend obliquely with respect to a bearing area (depicted by dashed lines) of the component carrier 2. In this case, the mounting area 4a forms an angle γ with the bearing area, where 0°<γ<90° holds true. The angle φ formed by the mounting area 4b with the bearing area can be 0° <φ<90°. The angle γ and the angle φ can be different or equal in magnitude.

FIG. 4 shows a luminous module 1 having a tetrahedral component carrier 2. The component carrier 2 has three side walls with triangular mounting areas 4a, 4b, 4c. The respective mounting areas 4a, 4b, 4c extend obliquely with respect to a bearing area illustrated in hatched fashion. Furthermore, the mounting areas 4a, 4b, 4c also extend obliquely with respect to one another. A respective semiconductor component 3 is mounted on the mounting areas 4a, 4b, 4c. By way of example, the semiconductor components 3 can be a red, a blue and a green light-emitting diode, such that the luminous module 3 emits white light overall. The arrangement is advantageously space-saving and additionally provides for good intermixing of the different-colored light.

The component carrier 2 is not embodied as a closed tetrahedron, but rather has a cavity on a side facing the bearing area, in which cavity a cooling element, for example, can be arranged.

In the case of the luminous module 1 illustrated in FIG. 5, the component carrier 2 of the luminous module 1 has the form of a pyramid. The component carrier 2 lacks the base area, such that only the mounting areas 4a, 4b, 4c, 4d are present. Consequently, the component carrier 2 is not embodied as a closed pyramid. The component carrier 2 encloses a cavity, in which a cooling element, for example, can be arranged.

FIG. 6 shows a luminous module 1 having a parallelepipedal component carrier 2. In this case, for the mounting of the semiconductor components 3, two side areas arranged parallel to one another are provided rather than the main area of the component carrier 2, which side areas thus serve as mounting areas 4a and 4b.

A luminous device 10 having relatively high reflectors 6 is illustrated in FIGS. 7 and 8, in contrast to the luminous device shown in FIGS. 1 and 2. In this case, the reflectors 6 extend as far as the covering plate 7. In particular, the reflectors 6 serve as supports for the covering plate 7, wherein the covering plate 7 bears on the upper edges 9 of the reflectors 6. As a result, the covering plate 7 is stabilized overall.

In this exemplary embodiment, the upper edges 9 touching the covering plate 7 form a boundary between adjacent luminous segments LS which is perceptible to an external observer. This is because the radiation intermixes more poorly at said boundaries than in regions between the upper edges 9.

The luminous segments LS arise as a result of the illumination of a planar area by means of a unit composed of a reflector 6 and at least one luminous module 1 arranged in the reflector 6. Since the reflector 6 in the present exemplary embodiment delimits the luminous module 1 only on two sides, the planar area can be illuminated line by line by a luminous module 1 arranged in a respective reflector 6. A prerequisite for this is that the luminous modules in the individual reflectors can be driven separately.

As revealed by FIGS. 7 and 8, the component carrier 2 has a form as described in greater detail in FIG. 3. This form has the effect that the components 3 which are arranged on the mounting area 4a are at a smaller distance from the components 3 which are arranged on the mounting area 4b than is the case for the component carrier 2 of the exemplary embodiment in FIGS. 1 and 2.

Any desired luminance and color homogeneity can be set by means of the distance between the components which are arranged on different mounting areas.

FIGS. 9 and 10 show a luminous device 10 having a plurality of reflectors 6 which surround on all sides the luminous modules 1 arranged in the reflectors 6. The contours of the reflectors 6 at the top side are rectangular, with the result that rectangular luminous segments respectively arise during the illumination of a planar area. Suitable aspect ratios of a rectangular luminous segment are 16:9 or 4:3, for example. The contour of the reflector 6 can accordingly have said aspect ratios. The aspect ratios are advantageously adapted to conventional screen formats.

Preferably, in this exemplary embodiment, the'luminous module 1 arranged in a reflector 6 can be driven separately from a luminous module 1 arranged in an adjacent reflector 6.

The luminous device 10 can be composed of individual units of plug-type design. Here, an individual unit comprises in each case a reflector 6 and at least one luminous module 1 arranged in the reflector 6. Furthermore, the unit comprises the electrical connections required. A luminous device of desired size can be constructed in this way. Since the units preferably have aspect ratios adapted to conventional screen formats, it is possible to produce a luminous device which, by virtue of its aspect ratios, is particularly suitable for backlighting a screen.

FIG. 11 illustrates a detailed complete view and FIG. 12 a detailed cross-sectional view of a preferred unit.

The unit comprises a reflector 6 and a luminous module surrounded on all sides by the reflector 6. The reflector 6 has an opening at the base, in which opening the luminous module 1 is arranged. In particular, the component carrier 2 closes off the opening at the base. The reflector 6 can be formed from a thermoformed plastic film.

The component carrier 2 has in cross section a trapezoid form and thus side areas extending obliquely with respect to one another which serve as mounting areas 4a and 4b.

The mounting areas 4a and 4b furthermore extend obliquely with respect to a connection plane (not illustrated) in which the luminous module 1 touches the reflector 6, and moreover obliquely with respect to a planar module carrier 12, on which the luminous module 1 is mounted. A comparatively good intermixing of the radiation generated by the semiconductor components 3 can be obtained as a result of the oblique arrangement of the semiconductor components 3 in the reflector 6. The semiconductor components 3 can have a plurality of semiconductor bodies, as illustrated.

As a result of the angular form of the component carrier 2, a cavity 5 is formed between said component carrier and the module carrier 12. A cooling element can be arranged in the cavity 5 which cooling element is preferably in direct contact with the component carrier 2, such that the heat that arises during operation can be dissipated directly. The cooling element 8 can be a cooling fin or a metal block which contains copper, in particular.

The component carrier 2 can be embodied as one part or in multipartite fashion. Preferably, for producing a multipartite component carrier 2, circuit boards are joined together. Particularly preferably, the circuit boards are then arranged on a hub (not illustrated). The circuit boards are metal-core circuit boards, in particular, which provide for good cooling of the luminous module 1. Furthermore, the circuit boards can be flexible, such that they can easily be bent and can thus assume any possible form. In addition to the semiconductor components 3, the luminous module 1 can have a sensor unit 11. By means of the sensor unit 11, the radiation emitted by semiconductor components 3 can be detected and set in accordance with the desired emission characteristic.

As is illustrated in FIG. 13, cable guides 13 provided for the electrical connection of the luminous module 1 can be accommodated in cavities 14 present between the component carrier 2 and the reflector 6.

FIG. 14 illustrates how a luminous device 10 can be constructed by joining together a plurality of units.

FIG. 15 is intended to illustrate a possible use of the cavity 5 below the component carrier 2 for cooling the luminous module 1. In accordance with the exemplary embodiment illustrated, the cooling is effected by means of cooling fins 15 which are arranged directly at the component carrier 2 and project into the cavity 5. Additional cooling can be effected by means of an air flow guided through the cavity 5.

The invention is not restricted by the description on the basis of the exemplary embodiments. Rather, the invention encompasses any novel feature and also any combination of features, which in particular includes any combination of features in the patent claims, even if this feature or this combination itself is not explicitly specified in the patent claims or exemplary embodiments.

1. A luminous device comprising at least one reflector and comprising at least one reflector and comprising at least one luminous module which has at least one radiation-emitting semiconductor component and a component carrier having at least one mounting area on which the radiation-emitting semiconductor component is mounted, wherein the luminous module is connected to the reflector in a connection plane defined by points of contact between the component carrier and the reflector,
wherein the mounting area extends obliquely with respect to the connection plane.

2. The luminous device as claimed in claim 1, wherein the luminous module is arranged within the reflector.

3. The luminous device as claimed in claim 1, wherein a cross-sectional area of the reflector which extends parallel to the connection plane becomes larger in the main emission direction.

4. The luminous device as claimed in claim 1, wherein the reflector has a symmetrical cross-sectional form in at least one plane arranged perpendicular to the connection plane.

5. The luminous device as claimed in claim 4, wherein the cross-sectional form is a parabola segment or a parabola, an ellipse segment, a hyperbola segment or a trapezoid segment.

6. The luminous device as claimed in claim 1, wherein the reflector is coated with a phosphor.

7. The luminous device as claimed in claim 1, wherein the reflector is formed from a plastic film.

8. The luminous device as claimed in claim 1, wherein the component carrier has at least one first and one second mounting area (4a, 4b) which extend obliquely with respect to one another.

9. The luminous device as claimed in claim 1, wherein the component carrier has at least one circuit board and the mounting area is the surface of the circuit board.

10. The luminous device as claimed in claim 1, wherein the component carrier has the form of a polyhedron.

11. The luminous device as claimed in claim 10, wherein the at least one mounting area is arranged parallel to a boundary face of the polyhedron.

12. The luminous device as claimed in claim 1, wherein the component carrier is a frame provided for guiding a cooling fluid flow or for arranging a cooling element.

13. The luminous device as claimed in claim 1, comprising a plurality of reflectors, wherein the at least one luminous module arranged in one reflector is in each case electrically driveable independently of the luminous modules arranged in the other reflectors.

14. The luminous device as claimed in claim 1, wherein a covering plate in the form of a diffuser or a backlighting element in the form of an LCD is disposed downstream of the reflector.

15. The luminous device as claimed in claim 14, wherein the mounting area extends obliquely with respect to a main area of the backlighting element.
